(19) United States
(12) Patent Application Publication
(10) Pub. No.: US 2012/0111260 A1
(43) Pub. Date: May 10, 2012

(54) MARKER TAB FOR THE REVERSIBLE ATTACHMENT TO A CORNER OF A PAGE

(76) Inventors: Niels Kleindienst, Berlin (DE); Marc Boeder, Berlin (DE); Paul Mueller-Osten, Berlin (DE)

(21) Appl. No.: 13/129,666

(22) PCT Filed: Nov. 16, 2009
(86) PCT No.: PCT/EP2009/008401

§ 371 Date: Jul. 27, 2011

(30) Foreign Application Priority Data
Nov. 17, 2008 (DE) 10 2008 058 307.3
Jul. 27, 2009 (DE) 10 2009 035 001.2

(51) Int. Cl. B42D 9/00

(52) U.S. Cl. 116/234

(57) ABSTRACT

The invention relates to a marker tab (1) for the reversible attachment to a corner (12) of a page (5), having the external shape of a triangle, wherein the sides (a, b) of the right-angle triangle are closed and the hypotenuse side (c) is open, so that an opening (3) is formed on the hypotenuse side (c) such that the marker tab (1) can be reversibly attached to the corner (12) of the page. According to the invention, one of the triangular layers (6) forms a predeterminable overhang (Ü, Ü′) with respect to the other triangular layer (7) on the hypotenuse side (c), wherein the overhang (Ü, Ü′) is provided with an adhesive agent (2) on the side facing the other layer (7), wherein the overhang (Ü, Ü′) is used on the one hand to secure the marker tab (1) reversibly and in a stable position to protect the corner (12) of the page, and on the other hand, the overhang (Ü, Ü′) is used to attach another identically designed second marker tab (1′) to the overhang (Ü, Ü), said other marker tab being reversibly fixable to the first marker tab (1) and being stackable in a stable position in a stack layer.

The invention relates to a marker tab for identifying pages, sheets and various print products, which can be reversibly attached to a corner of a page.

A folding tab for attachment to a longitudinal side of a page, which in its usage position forms a tab extension in form of a flag, is known in the art. Although the flag formed in the usage position can be used for applying text to the folding tab, the flag which extends over the end of the page is disadvantageously at risk of being bent, so that for example a book with several such folding tabs forming a flag quickly becomes objectionable and assumes an unprofessional appearance; in addition, the text applied on the flag may no longer be legible. Moreover, this type of folding tab is disadvantageously not suitable for securely protecting a corner of a page which has a particularly tendency to bend, and the folding tab, in order to be usable, must be folded from its original form, which also corresponds to its stack position, into its usage position, and must be folded outward again to return to its original form. A proper stack position in the original form can only achieved, without adding complexity, if the flag of the folding tab was not damaged or bent during use. The return into the stack position may therefore be relatively cumbersome or may not be possible at all, so that in practical applications a new folding tab is frequently resorted to.

A transparent attachment index, which is the subject matter of the published document DE 900 43 73 U1, is also known for protecting a corner of a page. The attachment index is composed of a rectangular double foil with a labeling pocket in variable sizes and shapes. Disadvantageously, this attachment index has no additional fixation on the corner of a page for securing the position of the attachment index on the corner of the page. Slight mechanical movements on a sheet of paper or on single or several pages of a book to which these indexes are attached can already cause the attachment index(es) to become detached or fall off.

It is the object of the invention to provide a marker tab for reversible attachment on a corner of a page, so that the marker tab can be easily temporarily affixed and reused and the marker tab can in the usage position attain a secure and defined position on a corner of a page.

The starting point is a marker tab for reversible attachment on a corner of a page having the outside shape of a rectangular triangle, wherein the two leg sides are closed and the hypotenuse side is open, so that an opening is formed on the hypotenuse side by a first rectangular layer of a predeterminable material of the marker tab disposed opposite a second rectangular layer of a predeterminable material, wherein the marker tab can be reversibly attached on the corner of the page in a usage position of the marker tab by pushing the marker tab on a corner of a page.

The object is solved in conjunction with the features of the preamble of claim 1 in that one of the triangular layers forms a predeterminable overhang with respect to the other triangular layer on the hypotenuse side, wherein the side of the overhang facing the other layer is provided with an adhesive agent. The overhang has hereby the function, on one hand, to affix the marker tab for protection of the corner of the page in its usage position securely, in a stable position as well as reversibly, through contact of the closed leg sides on the page edges of the corner of the page with the front and back side of the page, wherein the same overlap of the unchanged marker tab is, on the other hand, also used for reversibly affixing at least one additional identically formed second marker tab, which has a predeterminable overhang that faces away from the other layer, on the overhang of the first marker tab having the adhesive agent and stacking the second marker tab in a stable position in a stack layer.

A layer refers to a layer of material made, for example, from paper, plastic or from any other suitable material.

The material may hereby be rigid or flexible. The more stable the material is, the higher is the desired protection for the corner of the page. Particularly suitable for the first and/or second layer is therefore a material which is particularly thin, but still stable. According to the invention, the layers can be made from different materials having different properties, in particular different flexibility.

Preferably, a thin material is selected which is still stable enough so as to prevent bending of the corner of the page, wherein a tear-off pad made of at least 2 marker tabs can preferably be formed with such material. The material must therefore not have the tendency to fold or bend, because protection of the corner of a page would otherwise only be limited and only be caused by the overall reinforcement of the material of the attached marker tab.

The tear-off pad is thus formed of at least two identical marker tabs having the outside shape of a triangle, wherein the leg sides are closed and the hypotenuse side is open, thereby forming an opening on the hypotenuse side by a first rectangular layer of the marker tab opposite a second rectangular layer, wherein one of the layers opposite the other layer forms a predeterminable overhang on the hypotenuse side and the overhang is provided with an adhesive agent on the side facing the other layer. The side of the predeterminable overhang facing away from the other layer of the second identically formed marker tab is reversible affixable on the side of the overhang of the first marker tab which faces the other layer and includes the adhesive agent, and stackable in a stable position in a stack layer.

In other words, the overhang of the first marker tab, which has the adhesive agent on its front side, adheres to the back side of the overhang of the second marker tab, which does not have an adhesive agent.

Advantageous embodiments are recited in the dependent claims and are described in the corresponding description with reference to an exemplary embodiment. The appended figures show in:

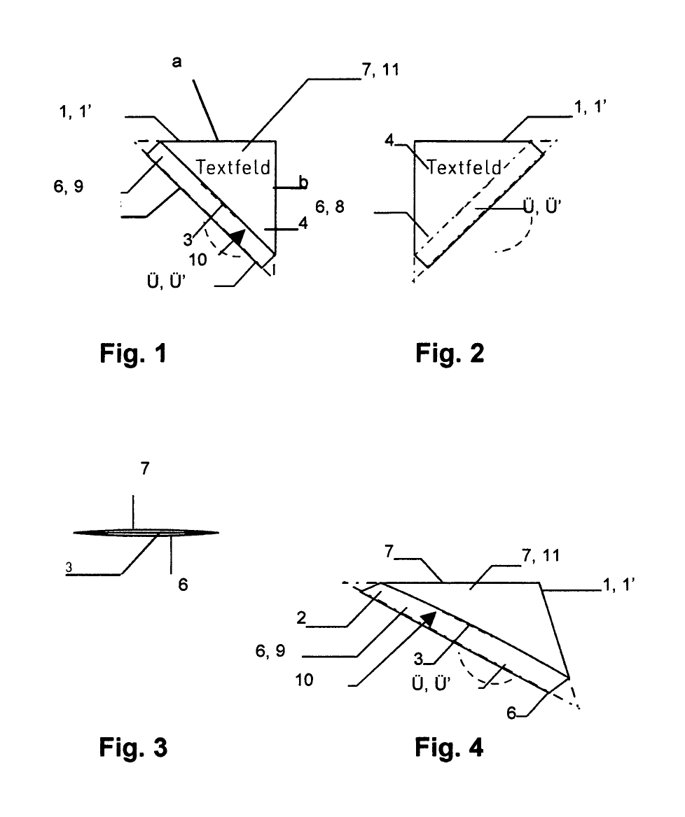

FIG. 1 a marker tab in a view onto a top side of a second layer and onto an overhang of the first layer;

FIG. 2 the marker tab in a view onto the bottom side of the second layer;

FIG. 3 the marker tab in a view onto its opening;

FIG. 4 the marker tab in a perspective view onto the top side;

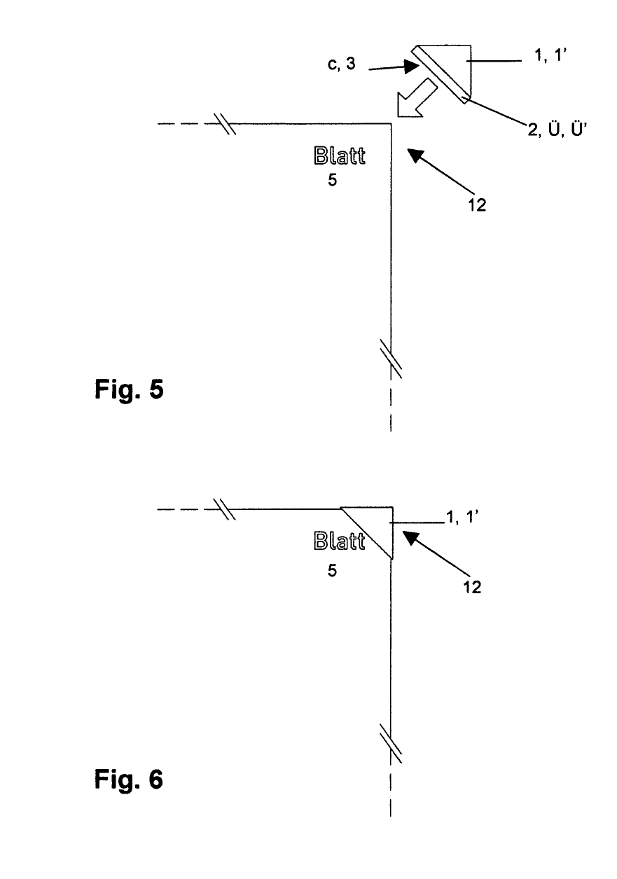

FIG. 5 the marker tab before a usage position relative to a corner of a page;

FIG. 6 the marker tab in a usage position on a corner of a page;

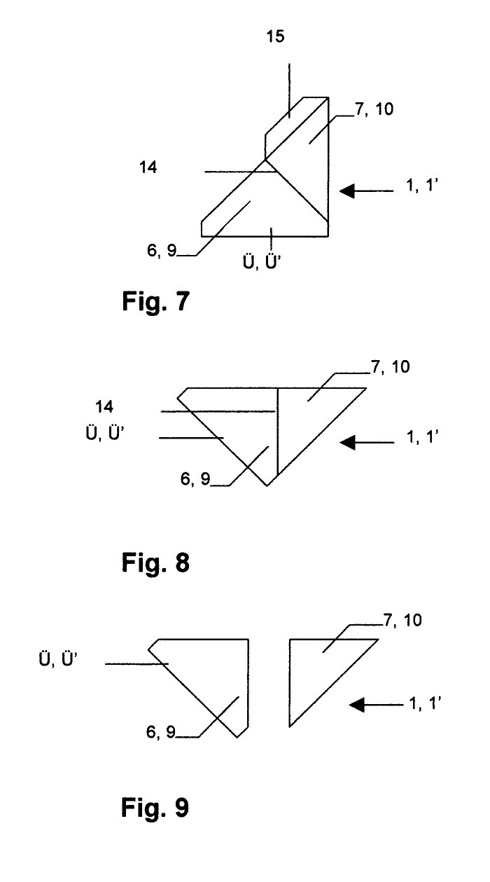

FIG. 7 the marker tab in a one-piece developed view;

FIG. 8 a marker tab in another one-piece developed view;

FIG. 9 the marker tab in a two-piece embodiment;

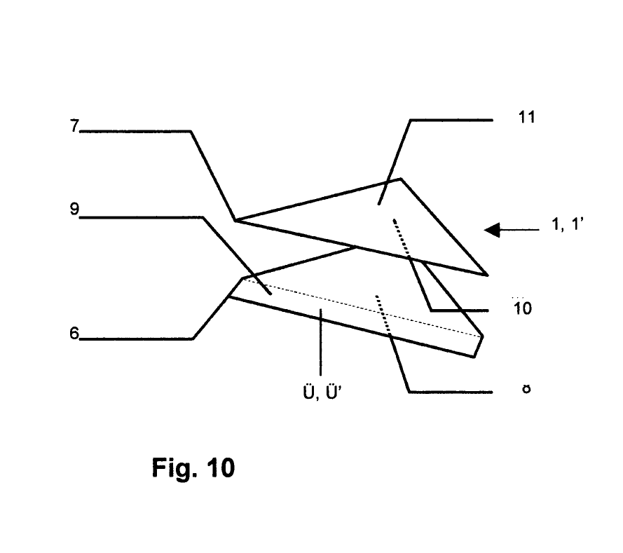

FIG. 10 the marker tab in an enlarged exploded view; and

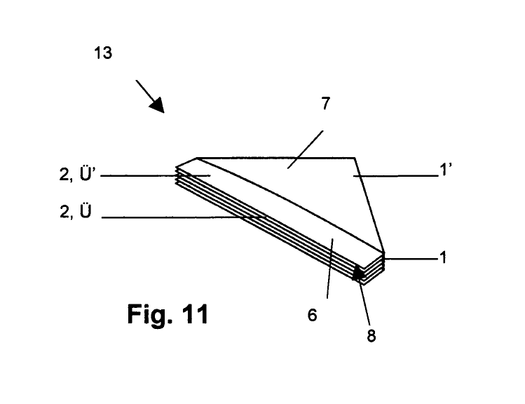

FIG. 11 a tear-off pad composed of several marker tabs.

FIG. 1 shows a marker tab 1, 1′ in a top view from the top side 11 of the second layer 7. The marker tab which is illustrated only once is provided with the reference symbol 1 and 1′. This indicates that a first marker tab 1 and a second marker tab 1′ are constructed identically. This identity with respect to shape and design is important for the stackability of the marker tabs 1, 1′ which will be described in more detail below.

During usage, the marker tab 1, 1′ is brought into a usage position which will be described below with reference to FIGS. 5 and 6, following the description of the design of the marker tab 1, 1′.

The marker tab 1, 1′ according to FIGS. 1 to 4 includes a first layer 6 which is arranged parallel to the second layer 7. The first layer 6 (FIG. 2) has a bottom side 8 and an only partially visible top side 9 (FIG. 1). The second layer 7 (FIG. 1) has an invisible bottom side 10 and the top side 11. The top side 9 of the first layer 6 and the bottom side 10 of the second layer 7 face each other. The bottom side 8 of the first layer 6 and the top side 11 of the second layer 7 can each be used for labeling the marker tab 1, 1′ with a text field 4.

The marker tab 1, 1′ has the form of a two-layer rectangular triangle, wherein a hypotenuse side c of the two layers 6, 7 is open. An opening 3 is thus formed on the hypotenuse side c between the layers 6 and 7. Conversely, a leg side a and b of the two layers 6, 7 is each closed.

One of the layers 6, 7—in the exemplary embodiment the first layer 6—has a rectangular overhang Ü, Ü′ connected to the hypotenuse side c of the first rectangular layer 6 which is indicated in the FIGS. 1 to 3 by a continuous line, wherein the overhang Ü, Ü′ is provided on the top side 9 of the first layer 6, which is visible in FIGS. 1 and 3, with an adhesive agent 2.

The overhang Ü, Ü′ can also be implemented, as shown in FIGS. 1 to 3 by the dash-dotted line—connected to the first triangular layer 6—as an isosceles trapeze.

The overhang Ü, Ü′ can also be implemented, as shown in FIGS. 1 to 3 by the dotted line—connected to the first triangular layer 6—in form of a droplet-shaped projection. More particularly, this embodiment of the overhang Ü, Ü′ saves material.

As illustrated in FIGS. 5 and 6, the hypotenuse-side opening 3 is pushed over the corner 12 of a page 5. In this exemplary embodiment the marker tab 1, 1′ is attached with a predeterminable overhang Ü, Ü′ for example on the back side of the page 5. An inverted arrangement is also possible, wherein the overhang Ü, Ü′ of the marker tab 1, 1′ provides the reversible attachment to a corner 12 of a page on the front side of the page 5.

The predeterminable overhang Ü, Ü′ of the top side 9 of the first layer 6 is here coated with an adhesive agent 2 of a type which allows the marker tab 1, 1′ to be attached and released multiple times.

The marker tab 1, 1′ abuts with its closed leg sides a and b of the two layers 6, 7 flush with the edges of the page 5—with an upper edge or a lower edge and a respective lateral edge. Particularly advantageously, the abutting arrangement of the leg sides a and b of the two layers 6, 7 on the edges of the page 5 is always secured, because after the marker tab 1, 1′ has been pushed to the limit stop on the edges of the page, the top or bottom side of the page 5 are reliably attached with the adhesive agent 2 applied to the overhang Ü, Ü′. The marker tab 1, 1′ remains in its secure usage position and does not detach from the corner 12 of the page 5 even if a page 5 is turned in the region of the corner 12 of the page or directly on a corner 12 of the page having a marker tab 1, 1′, thereby reliably preventing the corner 12 of the page from bending. When looking from the outside at a book or another print product, the visual appearance in the region of the corners 12 of the page is particularly tidy, because each marker tab 1, 1′ automatically abuts the corners 12 of a page when being pushed up to the closed leg sides a and b of the two layers 6, 7, therefore assuming exactly the same position defined by the overhang Ü, Ü′ that adheres to the page 5. Moreover, the perfect contact on the edges 12 of the page prevents regions from projecting over the edges of the page which could bend during transport of a book or the like. Identification is performed by the user through color identification of the marker tabs 1, 1′ and/or by way of the corresponding text field 4. Several pages 5 can be accommodated in one marker tab 1, 1′. The marker tab 1, 1′ can be manufactured in different sizes, so that several pages 5 can be accommodated in the intermediate space between the two layers 6 and 7 which receives the pages. The marker tab 1, 1′ can also be manufactured in different sizes, i.e., with leg sides and hypotenuse sides a, b, c having different lengths.

FIG. 7 shows the marker tab 1, 1′ in a one-piece developed view for a rectangular overhang Ü, Ü′ connected to the first triangular layer 6. The developed view shows the triangular surfaces of the top side 9 of the first layer 6 and the bottom side 10 of the second layer 7, which later face each other and are invisible. The rectangular overhang Ü, Ü′ is connected to the side which later forms the first layer 6. A tab 15 provided with adhesive is connected to the side which later forms the second layer 7. The developed view is folded at a fold 14 and the top side 9 of the first layer is folded onto the bottom side 10 of the second layer 7, whereby the tab 15 is then folded onto the already folded layer 6 and adhesively bonded on the top side of the folded side 6, which in the finished stage of the marker tab 1, 1′ forms the bottom side 8 of the first layer 6. The closed leg sides a and b are formed on the respective fold, and the opening 3 is, as intended, in the region of the overhang Ü, Ü′. However, this approach is not only suitable for manufacturing the marker tab 1, 1′ from paper material.

FIG. 8 shows the marker tab 1, 1′ in another one-piece developed view. In this solution, no tab 15 is provided. The folding process is performed on the fold 14 in an analogous manner. However, only one closed leg side is then formed on the fold edge. The remaining open leg side is preferably welded in the marginal region of the two layers 6, 7. Preferably, however, this approach is not only suitable for manufacturing the marker tab 1, 1′ from plastic material.

FIG. 9 shows the marker tab 1, 1′ in a two-piece embodiment. The two layers 6, 7 have neither a fold nor a tab and must be placed on top of each other according to FIGS. 1 to 8, wherein the two initially open leg sides are preferably welded or glued together. Preferably, however, this approach is not only suitable for manufacturing the marker tab 1, 1′ from plastic material.

FIG. 10 shows the marker tab 1, 1′ once more in an enlarged exploded view with the bottom side 8 and the top side 9 of the first layer 6 and the bottom side 10 and the top side 11 of the second layer 7 as well as the overhang Ü, Ü′ which faces the second layer 7 and has in FIG. 10 a rectangular shape.

FIG. 11 finally shows a tear-off pad 13 composed of several marker tabs, with the first marker tab 1 having a rectangular overhang Ü and the second marker tab 1′ having an identical rectangular overhang Ü′. On the formed stack, the second marker tab 1′ is located at the uppermost position. The side of the first identically formed marker tab 1 facing the other layer can be reversibly affixed on the overhang Ü′ of the second marker tab 1′ having the adhesive agent 2 and stacked in a stable position. The first marker tab 1 is therefore reversibly adhesively connected by way of its overhang Ü which has the adhesive agent 2 with the bottom side 8 of the first layer 6 of the overhang Ü′ of the second marker tab 1′ which does not have an adhesive agent 2. The tear-off pad 13 may have a base (not shown) in form of a support layer having an identical shape. This preferably more stable support layer provides greater stability for the tear-off pad 13 and protects the marker tab 1, 1′ from contamination, whereby the overhang of the support layer is already coated with the adhesive agent 2 for attaching the first marker tab 1 on the support layer.

LIST OF REFERENCES SYMBOLS

1 First marker tab

1′ Second marker tab

2 Adhesive agent

3 Opening of the marker tab

4 Text field

5 Page

6 First layer

7 Second layer

8 Bottom side of the first layer

9 Top side of the first layer

10 Bottom side of the second layer

11 Top side of the second layer

12 Corner of the page

13 Tear-off pad

14 Fold

15 Tab

Ü Predeterminable overhang

Ü′ Predeterminable overhang

a Leg side

b Leg side

c Hypotenuse

1. Marker tab (1) for the reversible attachment to a corner (12) of a page (5), having the external shape of a triangle, wherein the leg sides (a, b) are closed and the hypotenuse side (c) is open, so that an opening (3) is formed on the hypotenuse side (c) by a first triangular layer (6) of the marker tab (1) opposite a second triangular layer (7), so that in a usage position of the marker tab (1) where the marker tab (1) is pushed onto a corner (12) of a page, the marker tab (1) can be reversibly attached to the corner (12) of the page, wherein
one of the triangular layers (6) forms a predeterminable overhang (Ü, Ü′) with respect to the other triangular layer (7) on the hypotenuse side (c), wherein the overhang (Ü, Ü′) is provided with an adhesive agent (2) on the side facing the other layer (7),
wherein, on one hand, the overhang (Ü, Ü′) is used to secure the marker tab (1) reversibly and in a stable position on the front or back side of the page (5) for protecting the corner (12) of the page in the usage position through contact of the closed leg sides (a, b) with the page edges at the corner (12) of the page (5), and on the other hand, the overhang (Ü, Ü′) of the first marker tab (1) is used to attach another identically designed second marker tab (1′) to the overhang (Ü) provided with the adhesive agent (2), wherein the second marker tab (1′) can be reversibly affixed to the first marker tab (1) with the side of the overhang (Ü′) of the first layer (6) facing away from the second layer (7) and stacked in a stable position in a stack layer.

2. Marker tab (1, 1′) according to claim 1, wherein the marker tab (1, 1′) is provided with at least one text field (4) on at least one of the layers (6, 7).

3. Marker tab (1, 1′) according to claim 1, wherein the marker tab (1, 1′) can be fabricated in different colors for differentiation

4. Marker tab (1, 1′) according to claim 1, wherein the marker tab (1, 1′) is preferably made of a flexible or rigid paper or of a flexible or rigid plastic.

5. Marker tab (1, 1′) according to claim 1, wherein the marker tab (1, 1′) is made of a combination of a flexible or rigid paper and/or plastic, wherein the first layer (6) is rigid and the second layer (7) is flexible, or vice versa

6. Marker tab (1, 1′) according to claim 1, wherein the overhang (Ü, Ü′) of the first triangular layer (6) with respect to the second rigid or flexible layer (7) of the marker tap (1, 1′) is a rectangle or an isosceles trapeze or a projection in the shape of a droplet or a semi circle.

7. Tear-off pad (13) made of at least two identical marker tabs (1, 1′) having the outside shape of a triangle, wherein the leg sides (a, b) are closed and the hypotenuse side (c) is open, so that an opening (3) is formed on the hypotenuse side (c) by a first triangular layer (6) of the marker tab (1, 1′) opposite a second triangular layer (7), wherein one of the triangular layers (6) opposite the other triangular layer (7) forms a predeterminable overhang (Ü, Ü′) on the hypotenuse side (c), wherein the side of the overhang (Ü, Ü′) facing the other layer (7) is provided with an adhesive agent (2), wherein the second marker tab (1′) is reversibly affixed on the predeterminable overhang (Ü) of the first marker tab (1), which has the adhesive agent (2), via the overhang (Ü′) of the first layer (6) that faces away from the second layer (7) and stacked in a stable position in a stack layer.
